(19) United States
(12) Patent Application Publication
(10) Pub. No.: US 2007/0190398 A1
(43) Pub. Date: Aug. 16, 2007

(54) Electrode for fuel cell, fuel cell, and method of preparing electrode for fuel cell

(75) Inventors: Atsuo Sonai, Yokohama-shi (JP); Masaya Yano, Gunma (JP); Katsuyuki Tabata, Yokohama-si (JP); Kunihino Nakato, Gunma (JP)

Correspondence Address: STEIN, MCEWEN & BUI, LLP, 1400 EYE STREET, NW, SUITE 300, WASHINGTON, DC, 20005, US

(73) Assignees: Samsung SDI Co., Ltd., Suwon-si (KR); Samsung Electronics Co., Ltd., Suwon-si (KR); Sanyo Electronic Co., Ltd., Ooizumimatsi (JP)

(21) Appl. No.: 11/353,956

(22) Filed: Feb. 15, 2006

(51) Int. Cl. H01M 4/86; H01M 8/10; H01M 4/88; H01M 8/02

(52) U.S. Cl. 429/42; 429/30; 502/101; 429/38

(57) ABSTRACT

A fuel cell that operates at high temperature under non-humid conditions using an electrolyte membrane prepared by impregnating a basic polymer with an acid and a method of producing an electrode for a fuel cell, the fuel cell includes a catalyst layer electrode that can prevent the inhibition of gas diffusion due to generated water and the inhibition of gas diffusion due to an electrode catalyst being covered with an acid that leaks from the electrolyte membrane impregnated with the acid. The electrode includes a catalyst layer including a platinum-containing catalyst, a basic polymer, and a hydrophobic binder.

### BACKGROUND OF THE INVENTION

1. Field of the Invention

An aspect of the present invention relates to an electrode for a fuel cell, a fuel cell, and a method of preparing the electrode for a fuel cell, and more particularly, to an electrode for a fuel cell including an electrode catalyst layer suitable for operating at a high temperature under non-humid conditions, and a method of preparing the electrode for a fuel cell.

2. Description of the Related Art

Polymer electrolyte fuel cells (PEFCs), which include polymer electrolyte membranes as an electrolyte, operate at relatively low temperature and can be miniaturized. Due to these advantages, PEFCs are expected to be used as power sources for electric cars and in domestic distribution energy generating systems. Conventionally, a perfluorocarbonsulfonic acid-based polymer membrane, such as NAFION®, is used as a polymer electrolyte membrane for a PEFC.

The perfluorocarbonsulfone-based polymer membrane needs to be humidified because proton conductivity requires humidified conditions. In addition, in order to increase the efficiency of a fuel cell system, a high operating temperature of 100° C. or greater is required. However, at high temperature, an electrolyte membrane loses liquid and dries up. The dried-up electrolyte membrane fails to function as a solid electrolyte.

In order to overcome these problems, a non-humid electrolyte membrane that operates at 100° C. or higher under non-humid conditions has been developed. For example, Japanese Patent Publication No. hei 11-503262 discloses a non-humid electrolyte membrane formed of a phosphoric acid-doped polybenzimidazole, or the like.

Low temperature fuel cells using a perfulorocarbonsulfonic acid-based polymer membrane in many cases include an electrode having a hydrophobic property obtained by mixing the polymer membrane with polytetrafluoroethylene (PTFE), which is a water repelling agent. These fuel cells prevent inhibition of gas diffusion in the electrode due to water generated at an electrode, in particular, a cathode, during operation (see, for example, Japanese Patent Publication No. hei 05-283082.)

In phosphoric acid-based fuel cells (PAFCs) that operate at a high temperature of 150-200° C., a liquid phosphoric acid is used as an electrolyte. However, a large amount of the liquid phosphoric acid contained in an electrode inhibits gas diffusion. Accordingly, an electrode catalyst layer that includes an electrode catalyst mixed with PTFE described above and prevents clogging of pores of the electrode by the phosphoric acid is used (see, for example, J, Electroanal. Chem., 183, 391 (1985).)

When a basic polymer, such as polybenzimidazole (PBI), retaining a phosphoric acid, which is a high temperature non-humid electrolyte, is used in an electrolyte membrane of a fuel cell, an electrode can be impregnated with a liquid phosphoric acid such that the interface between the electrode and the membrane is homogeneous. However, such impregnation has no effects (see, for example, Uchida, Electrochemistry of Japan, 70(12) 943 (2002).)

### SUMMARY OF THE INVENTION

According to an aspect of the present invention, there is provided a fuel cell that includes an electrolyte membrane prepared by impregnating a basic polymer with an acid and operates at high temperature under non-humid conditions. The fuel cell includes a catalyst layer capable of preventing the inhibition of gas diffusion by water formation and capable of preventing the inhibition of gas diffusion by an electrode catalyst being covered with the acid.

According to another aspect of the present invention, there is provided an electrode for a fuel cell and a method of forming the electrode. The electrode includes a catalyst layer that contains a platinum-containing catalyst, a basic polymer, and a hydrophobic binding agent.

According to another aspect of the present invention, there is provided a fuel cell that generates energy when an electrolyte membrane is not humidified, the fuel cell including the electrode for a fuel cell.

According to another aspect of the present invention, there is provided a method of preparing an electrode for a fuel cell including: dispersing a platinum-containing catalyst in a solvent to prepare a dispersion solution; mixing the dispersion solution with a basic polymer solution, and a hydrophobic binding agent-containing solution, and then stirring the resultant mixture; and coating the resulting mixture on a carbon porous body.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a fuel cell according to an embodiment of the present invention; and

FIG. 2 is a graph of cell voltage with respect to current density of fuel cells according to Examples 1, 2 and 3 and Comparative Examples 1 and 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An electrode for a fuel cell according to an embodiment of the present invention is used in a fuel cell that can generate energy when an electrolyte membrane is not humidified. The electrode for a fuel cell includes a catalyst layer containing a platinum-containing catalyst, a basic polymer, and a hydrophobic binding agent.

A fuel cell according to an embodiment of the present invention can operate at 200° C. or less when an electrolyte membrane is not humidified. In the fuel cell, only an electrolyte membrane is impregnated with a phosphoric acid, and the electrode is not impregnated with a phosphoric acid. In this structure, the electrode may be impregnated with a relatively small amount of a phosphoric acid that has leaked from the electrolyte membrane. Accordingly, the electrode included in the fuel cell has a retaining property for holding a phosphoric acid or the like, and a retaining property for expelling generated water from the electrode.

In this structure, an acid solution leaks from the electrolyte membrane of the fuel cell which includes the basic polymer. In addition, due to the water-repelling property of a hydrophobic binding agent, water generated as a result of an energy generating reaction in the fuel cell can be removed from the electrode. Furthermore, the inhibition of reaction gas diffusion due to generated water in the electrode can be prevented. As a result, many three-phase interfaces between a gas phase (fuel gas or oxidant gas), a liquid phase (phosphoric acid), and a solid phase (catalyst) are formed at the surface of the catalyst of the electrode and characteristics of the fuel cell can be improved.

An electrode for a fuel cell according to an embodiment of the present invention has been described above. The basic polymer may include at least one compound selected from the group consisting of polybenzimidazole, poly(pyridine), poly(pyrimidine), polyimidazole, polybenzothiazole, polybenzooxazole, polyoxadiazole, polyquinoline, polyquinoxaline, polythiadiazole, poly(tetradipyrene), polyoxazole, polyvinylpyridine, polyvinylimidazole, and derivatives of these.

Since the basic polymer is included in the electrode, a phosphoric acid leaked from the electrolyte membrane can be held, and the electrode is not covered with phosphoric acid.

The hydrophobic binder may include at least one compound selected from the group consisting of poly(vinylidenefluoride), polytetrafluoroethylene, tetrafluoroethylene-hexafluoroethylene copolymer, and perfluoroethylene.

Since the hydrophobic binding agent is formed of a fluoride resin, water generated by an energy generating reaction can be efficiently removed from the electrode, and a three-phase interface can be easily formed.

The amount of the basic polymer is in the range of 1-20 parts by weight based on 1 part by weight of the catalyst. The amount of the hydrophobic binder is in the range of 1-20 parts by weight based on 1 part by weight of the catalyst. The total amount of the basic polymer and the hydrophobic binder is 21 parts by weight or less based on 1 part by weight of the catalyst, and for example, may be in the range of 5-20 parts by weight based on 1 part by weight of the catalyst.

Although the phosphoric acid is not added to the electrode when manufactured, the phosphoric acid leaks from the electrolyte due to the presence of the electrolyte membrane and the electrode contacting the membrane, thus the leaked phosphoric acid is transferred to the electrode. Accordingly, the amount of a phosphoric acid impregnated in the electrode is much less than that in a conventional electrode. Accordingly, a sufficient amount of the basic polymer, which is required to hold the phosphoric acid that is leaked from the electrolyte membrane, is 20 parts by weight or less based on 1 part by weight of a catalyst.

Since such a small amount of the phosphoric acid impregnates the electrode, the amount of the hydrophobic binder having a water-repelling property with respect to a phosphoric acid can be decreased to 20 parts by weight or less based on 1 part by weight of the catalyst, thereby decreasing an electric resistance of the electrode and increasing the energy generation efficiency of the fuel cell.

The fuel cell according to an embodiment of the present invention can generate energy when an electrolyte membrane is not humidified and includes the electrode for a fuel cell described above.

In this structure, many three-phase interfaces between a gas phase (fuel gas or oxidant gas), a liquid phase (phosphoric acid), and a solid phase (catalyst) are formed at the surface of the catalyst of the electrode. Thus, a fuel cell including such an electrode has excellent energy generation efficiency.

The electrolyte membrane is formed by impregnating a basic polymer with an acid. The basic polymer may include at least one compound selected from the group consisting of polybenzimidazole, poly(pyridine), poly(pyrimidine), polyimidazole, polybenzothiozole, polybenzooxazole, polyoxadiazole, polyquinoline, polyquinoxaline, polythiazole, poly(tetradipyrene), polyoxazole, polyvinylpyridine, polyvinylimidazole, and derivatives of these.

In this structure, since the electrolyte membrane contains the same basic polymer as the electrode for a fuel cell, the distribution of the phosphoric acid in the electrolyte membrane and the electrode is homogeneous and the energy generation efficiency can be increased.

In the fuel cell according to an embodiment of the present invention, the acid may include at least one acid selected from the group consisting of a phosphoric acid, a polyphosphoric acid, a phosphonic acid, and a sulfuric acid.

A method of producing an electrode for a fuel cell according to an embodiment of the present invention includes dispersing a platinum-containing catalyst in a solvent to prepare a dispersion solution; mixing the dispersion solution with a basic polymer solution, and a hydrophobic binding agent-containing solution, and then stirring the resulting mixture; and coating the resulting mixture on a carbon porous body.

The basic polymer and the hydrophobic binder are dissolved in solvents, respectively, and then added to the dispersion solution, the basic polymer and the hydrophobic binder are homogeneously mixed and thus an electrode, in which the catalyst, the basic polymer, and the hydrophobic binder are homogeneously dispersed, is formed.

### EMBODIMENTS

Hereinafter, embodiments of the present invention will be described with reference to the attached drawings.

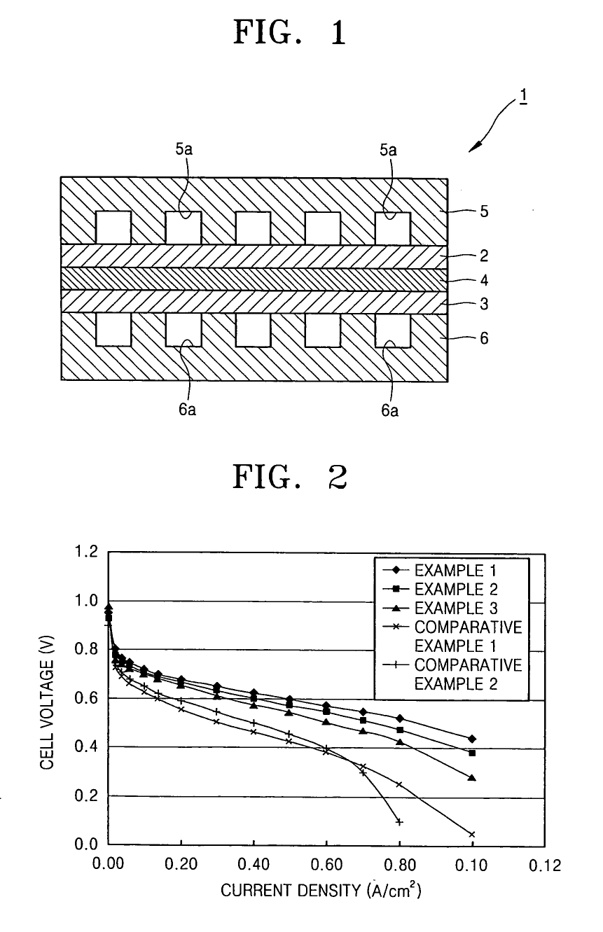

FIG. 1 is a cross-sectional view of a fuel cell 1 according to an embodiment of the present invention.

Referring to FIG. 1, the fuel cell 1 includes an oxygen electrode 2, a fuel electrode 3, a proton-conductive solid polymer electrolyte membrane 4 interposed between the oxygen electrode 2 and the fuel electrode 3 (hereinafter referred to as an electrolyte membrane 4), an oxidant bipolar plate 5 having an oxidant channel 5a outside the oxygen electrode 2, and a fuel bipolar plate 6 having a fuel channel 6a outside the fuel electrode 3. The fuel cell operates in a temperature range of 100-200° C.

The oxidant bipolar plate 5 and the fuel bipolar plate 6 are formed of a conductive metal or the like, and respectively contact the oxygen electrode 2 and the fuel electrode 3 to act as a current collector. The oxidant bipolar plate 5 and the fuel bipolar plate 6 supply the oxygen electrode 2 and the fuel electrode 3 with oxygen and fuel, respectively. That is, the fuel electrode 3 is supplied with hydrogen, which is a fuel, through the fuel channel 6a interposed between the fuel electrode 3 and the fuel bipolar plate 6. The oxygen electrode 2 is supplied with oxygen, which is an oxidant, through the oxidant channel 5a interposed between the oxygen electrode 2 and the oxidant bipolar plate 5. In this case, the hydrogen that is used as a fuel can be obtained through modification of hydrocarbon or alcohol, and the oxygen that is used as an oxidant may be supplied with air.

Hydrogen is oxidized in the fuel electrode 3, thus generating protons. The generated protons are transported to the oxygen electrode 2 through the electrolyte membrane 4. In the oxygen electrode 2, the protons and oxygen electrochemically react, thus producing water and electric energy.

In the electrolyte membrane 4, the basic polymer is impregnated with at least one acid selected from the group consisting of a phosphoric acid, a polyphosphoric acid, a phosphonic acid, and a sulfuric acid. For example, the basic polymer may be impregnated with an 85% by weights aqueous ortho phosphoric acid solution containing 85% by weight of H₃PO₄ and 15% by weight of water. In this case, the amount of the acid that is doped may be in the range of 200-1000 mol % per a functional group of the basic polymer. Since the basic polymer is impregnated with the phosphoric acid or the like, some of hydrogen ions (proton) of the phosphoric acid or the like are dissociated and thus, the electrolyte membrane 4 has ionic conductivity due to the dissociated protons.

Each of the oxygen electrode 2 and the fuel electrode 3 include an electrode catalyst (catalyst) prepared by impregnating an activated carbon with platinum, a hydrophobic binding agent that is used to mold the electrode catalyst in a solid phase, and a basic polymer. The catalyst layer is deposited on, for example, a porous carbon sheet (carbon porous body), and the oxygen electrode 2 and the fuel electrode 3 are each formed of the catalyst layer and the porous carbon sheet. The basic polymer holds phosphoric acid leaked from the electrolyte membrane 4. The hydrophobic binding agent expels water, which is generated by an energy generating reaction in the oxygen electrode 2, from the electrode, and thus the inhibition of gas diffusion due to the formation of water inside the electrode can be prevented. Therefore, many three-phase interfaces between a gas phase (fuel gas or oxidant gas), a liquid phase (phosphoric acid), and a solid phase (catalyst) are formed at the surface of the electrode catalyst contained in the oxygen electrode 2 and the fuel electrode 3, and thus, the characteristics of the fuel cell improves.

The basic polymer contained in the oxygen electrode 2, the fuel electrode 3, and the electrolyte 4 may include at least one compound selected from the group consisting of polybenzimidazole, poly(pyridine), poly(pyrimidine), polyimidazole, polybenzothiazole, polybenzooxazole, polyoxadiazole, polyquinoline, polyquinoxaline, polythiadiazole, poly(tetradipyrene), polyoxazole, polyvinylpyridine, polyvinylimidazole, and derivatives of these. For example, the basic polymer may be a polybenzimidazole represented by formula 1 below: 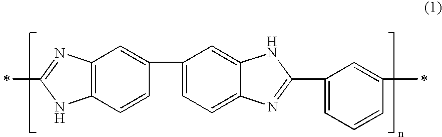
where n is an integer of 100-1000.

The weight average molecular weight of the basic polymer may be in the range of 1000-100,000. When the weight average molecular weight of the basic polymer is less than 1000, the basic polymer cannot closely neighbor the catalyst. When the weight average molecular weight of the basic polymer is greater than 100,000, it is difficult to dissolve the basic polymer in a solvent and the basic polymer cannot be mixed with the catalyst.

The hydrophobic binder that is used in the oxygen electrode 2 and the fuel electrode 3 may include at least one fluoride resin selected from the group consisting of poly(vinylidenefluoride), polytetrafluoroethylene, tetrafluoroethylene-hexafluoroethylene copolymer, and perfluoroethylene.

The composition of the catalyst layer included in the oxygen electrode 2 and the fuel electrode 3 will now be described. The amount of a basic polymer in the catalyst layer may be in the range of 1-20 parts by weight based on 1 part by weight of the catalyst. When the amount of the basic polymer is less than 1 part by weight, the acid leaked from the electrolyte membrane 4 is insufficiently absorbed, and when the amount of the basic polymer is greater than 20 parts by weight, the resistance of the catalyst layer increases due to the basic polymer, which is an insulator, and the characteristics of the fuel cell degrade. The amount of the binder may be in the range of 1-20 parts by weights based on 1 part by weight of the catalyst. When the amount of the binder is less than 1 part by weight, the binder cannot bind the catalyst powder, and thus, the mechanical strength of the catalyst layer decreases and the electrode including such a catalyst layer fails to act as an electrode. When the amount of the binder is greater than 20 parts by weight, the resistance of the catalyst layer increases due to the binder, which is an insulator, and the hydrophobicity of the electrode is too strong. As a result, the acid with a small thickness cannot be covered on the surface of the catalyst, thus a reaction area is substantially decreased and the characteristics of the fuel cell deteriorate.

The oxygen electrode 2 and the fuel electrode 3 can hold an acid leaked from an electrolyte membrane 4 because of the basic polymer. In addition, a hydrophobic binder having a water-repelling property can expel water from the electrode, which is generated as a result of an energy generating reaction of the fuel cell, and inhibit gas reaction diffusion in the electrode caused by the water. Accordingly, many three-phase interfaces between a gas phase (fuel gas or oxidant gas), a liquid phase (phosphoric acid), and a solid phase (catalyst) are formed at the surface of the electrode, thereby improving fuel cell characteristics.

A method of producing an electrode for a fuel cell will now be described.

The method includes dispersing a platinum-containing catalyst in a solvent to prepare a dispersion solution; mixing the dispersion solution, a basic polymer solution, and a hydrophobic binder-containing solution; and coating the resulting mixture on a carbon porous body.

When dispersing of the platinum-containing catalyst in a solvent, the solvent may be water; an alcohol, such as methanol, ethanol, 1-propanol, 2-propanol, butanol, or the like; hydrocarbonates, toluene, xylene, or the like; a halogenated hydrocarbonates, such as methyl chloride, methylene chloride, or the like; a fatty acid ester, such as methyl acetate, ethyl acetate, or the like; an ether, such as ethylcellosolve, or the like; a ketone, such as acetone, methylethylketone, or the like; or an aprotic polar solvent, such as N,N-dimethylacetamide, N-methyl-2-pyrrolidone, dimethylsufoxide, dimethyl carbonate, or the like. The catalyst may be prepared by impregnating activated carbon with platinum, as described above. The catalyst is a powder and the average diameter thereof may be in the range of 0.1-1 μm. The catalyst and the solvent may be mixed in a mixture ratio of 1:20-1:5. The catalyst is added to the solvent and then sufficiently stirred, thereby preparing a dispersion solution containing the catalyst.

The mixing of the dispersion solution with the basic polymer solution, and the hydrophobic binder-containing solution, the mixing may further include preparing a basic polymer solution and mixing the basic polymer solution with the dispersion solution. When preparing the basic polymer, a solution in which the basic polymer is to be dissolved may be water; an alcohol, such as methanol, ethanol, 1-propanol, 2-propanol, butanol, or the like; hydrocarbonates, toluene, xylene, or the like; a halogenated hydrocarbonates, such as methyl chloride, methylene chloride, or the like; a fatty acid ester, such as methyl acetate, ethyl acetate, or the like; an ether, such as ethylcellosolve, or the like; a ketone, such as acetone, methylethylketone, or the like; or an aprotic polar solvent, such as N,N-dimethylacetamide, N-methyl-2-pyrrolidone, dimethylsufoxide, dimethyl carbonate, or the like. In this case, the solution in which the basic polymer is dissolved may have a concentration of 1-20% by weight.

When t mixing the dispersion solution and the basic polymer solution, the dispersion solution and the basic polymer solution are mixed such that the weight ratio of the catalyst to the basic polymer is in the range of 1:0.01-1:0.3.

The hydrophobic binder-containing solution is prepared and mixed with the mixture of the dispersion solution and the basic polymer solution. When preparing the hydrophobic binder-containing solution, a solution in which the hydrophobic binder is to be dissolved may be water; an alcohol, such as methanol, ethanol, 1-propanol, 2-propanol, butanol, or the like; hydrocarbonates, toluene, xylene, or the like; a halogenated hydrocarbonates, such as methyl chloride, methylene chloride, or the like; a fatty acid ester, such as methyl acetate, ethyl acetate, or the like; an ether, such as ethylcellosolve, or the like; a ketone, such as acetone, methylethylketone, or the like; or an aprotic polar solvent, such as N,N-dimethylacetamide, N-methyl-2-pyrrolidone, dimethylsufoxide, dimethyl carbonate, or the like; or a fluoride-based inactive solvent, such as hydroperfluoromethylether, or the like. The solution in which the hydrophobic binder is dissolved may have a concentration of 1-20% by weight.

When mixing the hydrophobic binder-containing solution with the solution mixture of the dispersion solution and the basic polymer solution, the solution mixture of the dispersion solution and the basic polymer solution is mixed with the hydrophobic binder-containing solution such that the weight ratio of the catalyst to the hydrophobic binder is in the range of 1:0.1-1:0.2. As described above, the basic polymer and the hydrophobic binder are first dissolved in solvents and then added to the dispersion solution, and the catalyst is dispersed in the resulting mixture.

When mixing the dispersion solution, the basic polymer solution, and the hydrophobic binder-containing solution, the basic polymer solution and the hydrophobic binding agent-containing solution may be added to the dispersion solution at the same time, or one of the basic polymer solution and the hydrophobic binder-containing solution may be first added.

Next, when coating the mixture on the carbon porous body, the mixture may be coated on the carbon porous body using, for example, a screen printing method, and then heated to 60-300° C. under a vacuum condition, air, or an inert gas atmosphere to vaporize the solvents. As a result, a catalyst layer containing the catalyst, the basic polymer, and the hydrophobic binder is formed on the carbon porous body.

As described above, a basic polymer and a hydrophobic binder are dissolved in solvents, respectively, and then added to a dispersion solution. Therefore, the basic polymer and the hydrophobic binder can be homogeneously mixed and an electrode in which a catalyst, a basic polymer, and a hydrophobic binder are homogeneously dispersed can be produced.

### EXAMPLES

An aspect of the present invention will be described in further detail with reference to the following examples. These examples are for illustrative purposes only and are not intended to limit the scope of the present invention.

### Example 1

An electrode according to an embodiment of the present invention was prepared in the following manner. 1.5 g of a platinum-containing catalyst in which 50% of the platinum was supported by carbon (Vulcan XC72) was measured while contained in a beaker, and then 3.0 g of N-methylpyrrolidone (NMP) as a solvent was added thereto and mixed at room temperature for one hour until a homogeneous solution of the catalyst and the solvent was attained.

Then, a 10% by weight of a poly(vinylidenefluoride) solution was prepared by dissolving a KF polymer (produced from Kureha) in NMP as a solvent, and the poly(vinylidenefluoride) solution was mixed with the catalyst-containing solution. In this case, the poly(vinylidenefluoride) solution was slowly dropped into the catalyst-containing solution until the amount of poly(vinylidenefluoride) was 2.5 parts by weight based on 1 part by weight of the catalyst, and the result was mixed for one hour.

Next, a 1% by weight of a polybenzimidazole solution was prepared using dimethylformamid as a solvent. The prepared 1% by weight of polybenzimidazole solution was slowly dropped into the catalyst and binder-containing solution until the amount of the polybenzimidazole was 5% by weight based on 1% by weight of the catalyst, and then mixed for one day. As a result, a catalyst slurry was attained.

The catalyst slurry was doped on a carbon paper having a microcarbon layer, and the result was dried in a vacuum conduction at 150° C. for about 1 hour to remove the solvent. As a result, the electrode for a fuel cell according to Example 1 was produced.

### Example 2

An electrode for a fuel cell according to Example 2 was produced in the same manner as in Example 1, except that the amount of poly(vinylidenefluoride) was 1.25 parts by weight and the amount of polybenzimidazole was 6.25 parts by weight, based on 1 part by weight of the catalyst.

### Example 3

An electrode for a fuel cell according to Example 3 was produced in the same manner as in Example 1, except that the amount of poly(vinylidenefluoride) was 3.75 parts by weight based on 1 part by weight of the catalyst and the amount of polybenzimidazole was 3.75 parts by weight based on 1 part by weight of platinum contained in the catalyst.

### Comparative Example 1

An electrode for a fuel cell according to Comparative Example 1 was produced in the same manner as in Example 1, except that the polybenzimidazole solution was not added and the amount of poly(vinylidenefluoride) was 7.5 parts by weight based on 1 part by weight of the catalyst.

(Comparative Example 2)

An electrode for a fuel cell according to Comparative Example 2 was produced in the same manner as in Example 1, except that the poly(vinylidenefluoride) solution was not added and the amount of polybenzimidazole was 7.5 parts by weight based on 1 part by weight of the catalyst.

Measurements

Each of the electrodes according to Examples 1, 2 and 3 and Comparative Examples 1 and 2 was assembled with an electrolyte membrane prepared by doping 1000 mol % of phosphoric acid (based on a basic functional group of polybenzimidazole) on a polybenzimidazole membrane such that the electrolyte membrane was interposed between a pair of electrodes (fuel electrode and oxygen electrode), thereby producing a fuel cell. These fuel cells operated at 150° C. by supplying the fuel electrode and the oxygen electrode with hydrogen and air, respectively, to measure their characteristics. In this case, the electrolyte membrane was not humidified. The results are shown in FIG. 2.

Referring to FIG. 2, the fuel cell using the electrode according to Comparative Example 1 in which only the catalyst and the poly(vinylidenefluoride) were used exhibited a dramatic drop in voltage when current density was low. This result might stem from a phosphoric acid leaking from the electrolyte membrane and coating the catalyst to a great thickness, thereby reducing a reaction area.

The fuel cell using the electrode according to Comparative Example 2 in which only the catalyst and the polybenzimidazole were used exhibited a dramatic drop of voltage in low and high current density regions. This result might stem from generated water not being removed, and adsorbed water reducing the reaction area.

Meanwhile, the fuel cells using the electrodes according to Examples 1, 2, and 3 exhibited a small voltage drop in low and high current density regions and good performance. In this case, gas diffusion was secured due to the hydrophobic property of the binder, and the basic polymer adsorbed the phosphoric acid that leaked so that the catalyst was humidified to a proper level.

Accordingly, a fuel cell that can operate at high temperature under non-humid conditions including an electrode for a fuel cell according to an aspect of the present invention has excellent energy generation characteristics.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrode for a fuel cell that generates energy when an electrolyte membrane is not humidified, the electrode comprising:
a catalyst comprising platinum;
a basic polymer; and
a hydrophobic binder.

2. The electrode of claim 1, wherein the basic polymer comprises at least one compound selected from the group consisting of polybenzimidazole, poly(pyridine), poly(pyrimidine), polyimidazole, polybenzothiazole, polybenzooxazole, polyoxadiazole, polyquinoline, polyquinoxaline, polythiadiazole, poly(tetradipyrene), polyoxazole, polyvinylpyridine, polyvinylimidazole, and derivatives thereof.

3. The electrode of claim 1, wherein the hydrophobic binder comprises at least one compound selected from the group consisting of poly(vinylidenefluoride), polytetrafluoroethylene, tetrafluoroethylene-hexafluoroethylene copolymer, and perfluoroethylene.

4. The electrode of claim 1, wherein
an amount of the basic polymer is in a range of 1-20 parts by weight based on 1 part by weight of the catalyst,
an amount of the hydrophobic binder is in a range of 1-20 parts by weight based on 1 part by weight of the catalyst, and
a total amount of the basic polymer and the hydrophobic binder is 21 parts by weight or less based on 1 part by weight of the catalyst.

5. A fuel cell that generates energy when an electrolyte membrane is not humidified, the fuel cell comprising:
an electrode including a catalyst comprising platinum;
a basic polymer; and
a hydrophobic binder.

6. The fuel cell of claim 5, wherein the basic polymer comprises at least one compound selected from the group consisting of polybenzimidazole, poly(pyridine), poly(pyrimidine), polyimidazole, polybenzothiazole, polybenzooxazole, polyoxadiazole, polyquinoline, polyquinoxaline, polythiadiazole, poly(tetradipyrene), polyoxazole, polyvinylpyridine, polyvinylimidazole, and derivatives thereof.

7. The fuel cell of claim 5, wherein the hydrophobic binder comprises at least one compound selected from the group consisting of poly(vinylidenefluoride), polytetrafluoroethylene, tetrafluoroethylene-hexafluoroethylene copolymer, and perfluoroethylene.

8. The fuel cell of claim 5, wherein an amount of the basic polymer is in a range of 1-20 parts by weight based on 1 part by weight of the catalyst,
an amount of the hydrophobic binder is in a range of 1-20 parts by weight based on 1 part by weight of the catalyst, and
a total amount of the basic polymer and the hydrophobic binder is 21 parts by weight or less based on 1 part by weight of the catalyst.

9. The fuel cell of claim 5, wherein the electrolyte membrane is prepared by impregnating the basic polymer with an acid.

10. The fuel cell of claim 9, wherein the acid comprises at least one acid selected from the group consisting of a phosphoric acid, a polyphosphoric acid, a phosphonic acid, and a sulfuric acid.

11. A method of producing an electrode for a fuel cell, the method comprising:
dispersing a platinum-containing catalyst in a solvent to prepare a dispersion solution;
mixing the dispersion solution with a basic polymer solution, and a hydrophobic binder, and then stirring the resulting mixture; and
coating the resulting mixture on a carbon porous body.

12. The method of claim 12, wherein the platinum-containing catalyst is prepared by impregnating an activated carbon with platinum.

13. A fuel cell comprising:
a first electrode;
a second electrode;
an electrolyte membrane interposed between the first and the second electrode;
a first bipolar plate formed on the first electrode; and
a second bipolar plate formed on the second electrode,
wherein the first and the second electrodes each include a catalyst, a hydrophobic binder and a basic polymer.

14. The fuel cell of claim 13, wherein the catalyst includes platinum.

15. The fuel cell of claim 13, wherein the basic polymer comprises at least one compound selected from the group consisting of polybenzimidazole, poly(pyridine), poly(pyrimidine), polyimidazole, polybenzothiazole, polybenzooxazole, polyoxadiazole, polyquinoline, polyquinoxaline, polythiadiazole, poly(tetradipyrene), polyoxazole, polyvinylpyridine, polyvinylimidazole, and derivatives of these.

16. The fuel cell of claim 13, wherein the hydrophobic binder comprises at least one compound selected from the group consisting of poly(vinylidenefluoride), polytetrafluoroethylene, tetrafluoroethylene-hexafluoroethylene copolymer, and perfluoroethylene.

17. The fuel cell of claim 13, wherein the first and second bipolar plates include channels supplying oxygen and hydrogen to the first and second electrodes, respectively.

18. The fuel cell of claim 13, wherein an amount of the basic polymer is in a range of 1-20 parts by weight based on 1 part by weight of the catalyst,
an amount of the hydrophobic binder is in a range of 1-20 parts by weight based on 1 part by weight of the catalyst, and
a total amount of the basic polymer and the hydrophobic binder is 21 parts by weight or less based on 1 part by weight of the catalyst.
